(19) United States
(12) Patent Application Publication
(10) Pub. No.: US 2026/0143425 A1
(43) Pub. Date: May 21, 2026

(54) Anchor Carrier for Network Energy Saving

(71) Applicant: Apple Inc., Cupertino, CA (US)

(72) Inventors: Peng CHENG, Beijing (CN); Fangli XU, Beijing (CN); Haijing HU, Los Gatos, CA (US); Yuqin CHEN, Beijing (CN)

(21) Appl. No.: 19/118,905

(22) PCT Filed: Oct. 10, 2023
(86) PCT No.: PCT/US2023/034793

§ 371 Date: Apr. 7, 2025

Related U.S. Application Data
(60) Provisional application No. 63/378,951, filed on Oct. 10, 2022.

(51) Int. Cl. H04W 52/02; H04W 76/27

(52) U.S. Cl. CPC H04W 52/0229; H04W 76/27

(57) ABSTRACT

A user equipment (UE) configure to perform initial access on an anchor carrier of a fifth generation (5G) new radio (NR) network and monitor a non-anchor carrier for a unicast transmission, wherein the non-anchor carrier does not broadcast synchronization signal blocks (SSBs). In some cases, the non-anchor carrier does not broadcast system information blocks (SIBs).

### PRIORITY/INCORPORATION BY REFERENCE

This application claims priority to U.S. Provisional Application Ser. No. 63/378,951 filed on Oct. 10, 2022 and entitled, “Anchor Carrier for Network Energy Saving,” the entirety of which is incorporated by reference herein.

### BACKGROUND

In a multi-carrier deployment scenario, a user equipment (UE) may be configured with an anchor carrier and a non-anchor carrier. It has been identified that the use of an anchor carrier may provide network energy saving benefits.

Accordingly, there is a need for techniques configured to support the implementation of an anchor carrier for network energy saving.

### SUMMARY

Some example embodiments are related to an apparatus of a user equipment (UE), the apparatus having processing circuitry configure to perform initial access on an anchor carrier of a fifth generation (5G) new radio (NR) network and monitor a non-anchor carrier for a unicast transmission, wherein the non-anchor carrier does not broadcast synchronization signal blocks (SSBs).

Other example embodiments are related to a method performed by a user equipment (UE). The method includes performing initial access on an anchor carrier of a fifth generation (5G) new radio (NR) network and monitoring a non-anchor carrier for a unicast transmission, wherein the non-anchor carrier does not broadcast synchronization signal blocks (SSBs).

### BRIEF DESCRIPTION OF THE DRAWINGS

FIG. 1 shows an exemplary network arrangement according to various exemplary embodiments.

FIG. 2 shows an exemplary user equipment (UE) according to various exemplary embodiments.

FIG. 3 shows an exemplary base station according to various exemplary embodiments.

FIG. 4 shows a method for anchor carrier operation according to various exemplary embodiments.

### DETAILED DESCRIPTION

The exemplary embodiments may be further understood with reference to the following description and the related appended drawings, wherein like elements are provided with the same reference numerals. The exemplary embodiments introduce techniques to support the implementation of an anchor carrier for network energy saving.

The exemplary embodiments are described with regard to a user equipment (UE). However, reference to a UE is merely provided for illustrative purposes. The exemplary embodiments may be utilized with any electronic component that may establish a connection to a network and is configured with the hardware, software, and/or firmware to exchange information and data with the network. Therefore, the UE as described herein is used to represent any electronic component.

The exemplary embodiments are also described with regard to a fifth generation (5G) New Radio (NR) network.

However, reference to a 5G NR network is merely provided for illustrative purposes. The exemplary embodiments may be utilized with any appropriate type of network that may utilize an anchor carrier for network energy saving.

The exemplary embodiments are described with regard to a multi-carrier deployment scenario comprising at least a first carrier and a second carrier. Those skilled in the art will understand that a carrier generally refers to one or more frequency bands operated by a cell of a base station (e. g., gNB). Throughout this description, to differentiate between different carriers, reference may be made to “carrier 1” and “carrier 2.” However, any references to either carrier 1 or carrier 2 possessing certain characteristics or exhibiting specific behavior are merely provided as non-limiting examples. The carrier 1 and carrier 2 classifications are not intended to limit the exemplary embodiments in any way and are only intended to differentiate between carriers in a multi-carrier deployment scenario. The exemplary embodiments described herein may be utilized by a multi-carrier system comprising any number of carriers deployed by any appropriate number of base stations.

In some multi-carrier deployment scenarios, a carrier may be configured as an anchor carrier or a non-anchor carrier. Generally, the term “anchor carrier” may refer to a carrier on which the UE assumes that certain types of synchronization information are to be transmitted. To provide some non-limiting examples, the UE may assume that the anchor carrier is to transit primary synchronization signals (PSS), secondary synchronization signal (SSS), public broadcast channel (PBCH), system information block 1 (SIB1), random access channel (RACH) and paging. The term “non-anchor” carrier may refer to a carrier on which the UE assumes that certain types of synchronization information is not to be transmitted. A general overview of anchor carrier operation is provided in the following paragraph to illustrate some non-limiting examples of interactions that may occur between a UE, an anchor carrier and non-anchor carriers in a multi-carrier system. However, the various examples provided throughout this description are not intended to limit the scope of the terms “anchor carrier” and “non-anchor carrier” in any way. The terms “anchor carrier” and “non-anchor carrier” are defined in various 3GPP documents. The anchor carrier and non-anchor carrier described herein may behave in the manner in which they are defined in 3GPP documents and in accordance with the exemplary embodiments described herein.

To provide a general overview of a multi-carrier deployment scenario involving an anchor carrier and a non-anchor carrier, consider a scenario in which the UE is camped on a cell operating on carrier 1. Initially, the UE may perform a RACH procedure with carrier 1 for initial access to a 5G NR network. After completion of the RACH procedure, the UE may be configured with one or more non-anchor carriers (e.g., carrier 2, etc.).

The UE may exchange data on the non-anchor carrier when the UE is operating in radio resource control (RRC) connected mode (e.g., physical downlink control channel (PDCCH), physical uplink control channel (PUCCH), physical downlink shared channel (PDSCH), physical uplink shared channel (PUSCH), etc.). However, the non-anchor carrier may not transmit certain types of synchronization information (e.g., SSB, PBCH, SIB1, etc.) which may provide energy saving opportunities on the network side. While the exemplary embodiments support the implementation of an anchor carrier for network energy saving, specific network energy saving techniques are beyond the scope of the exemplary embodiments and the exemplary embodiments may be used regardless of whether network energy saving is achieved.

The exemplary embodiments introduce techniques to support the implementation of an anchor carrier for network energy saving. As will be described in more detail below, the exemplary embodiments relate to various aspects of a multi-carrier system such as, but not limited to, collecting measurement data from an anchor carrier, collecting measurement data from a non-anchor carrier, radio link monitoring (RLM), beam failure, RACH and paging. The exemplary techniques introduced herein may be used independently from one another, in conjunction with other currently implemented anchor carrier mechanisms, in conjunction with future implementations of anchor carrier mechanisms and independently from other anchor carrier mechanisms.

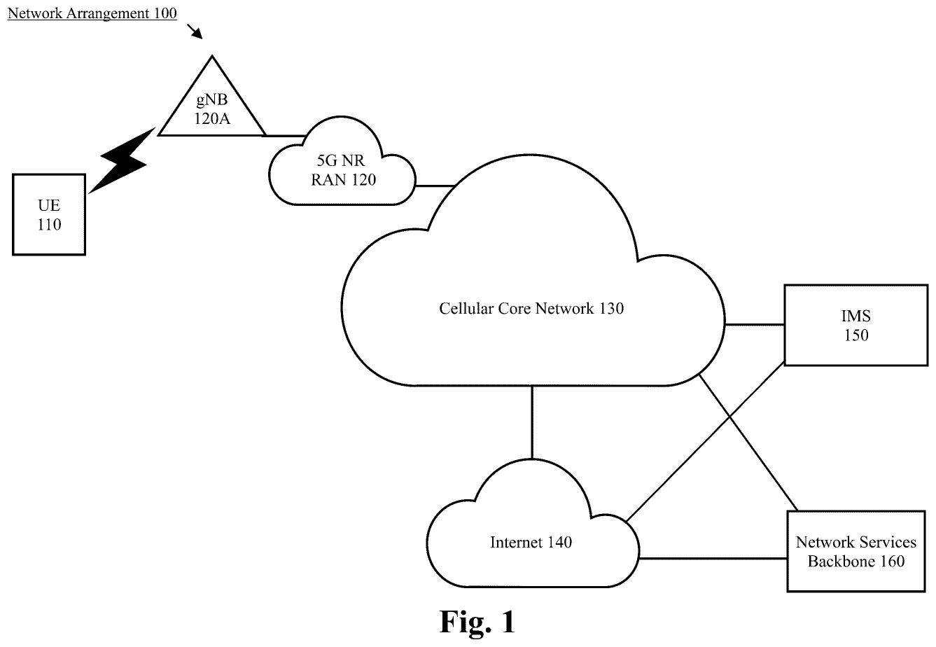

FIG. 1 shows an exemplary network arrangement 100 according to various exemplary embodiments. The exemplary network arrangement 100 includes a UE 110. Those skilled in the art will understand that the UE 110 may be any type of electronic component that is configured to communicate via a network, e.g., mobile phones, tablet computers, desktop computers, smartphones, phablets, embedded devices, wearables, Internet of Things (IOT) devices, etc. It should also be understood that an actual network arrangement may include any number of UEs being used by any number of users. Thus, the example of a single UE 110 is merely provided for illustrative purposes.

The UE 110 may be configured to communicate with one or more networks. In the example of the network configuration 100, the network with which the UE 110 may wirelessly communicate is a 5G NR radio access network (RAN) 120. However, the UE 110 may also communicate with other types of networks (e. g., a 6G RAN, a 5G cloud RAN, a next generation RAN (NG-RAN), a long term evolution (LTE) RAN, a legacy cellular network, a wireless local area network (WLAN), etc. ) and the UE 110 may also communicate with networks over a wired connection. With regard to the exemplary embodiments, the UE 110 may establish a connection with the 5G NR RAN 120. Therefore, the UE 110 may have at least a 5G NR chipset to communicate with the NR RAN 120.

The 5G NR RAN 120 may be a portion of a cellular network that may be deployed by a network carrier (e.g., Verizon, AT&T, T-Mobile, etc.). The 5G NR RAN 120 may include, for example, base stations or access nodes (Node Bs, eNodeBs, HeNBs, eNBS, gNBs, gNodeBs, macrocells, microcells, small cells, femtocells, etc.) that are configured to send and receive traffic from UEs that are equipped with the appropriate cellular chip set.

Those skilled in the art will understand that any association procedure may be performed for the UE 110 to connect to the 5G NR RAN 120. For example, as discussed above, the 5G NR RAN 120 may be associated with a particular cellular provider where the UE 110 and/or the user thereof has a contract and credential information (e.g., stored on a SIM card). Upon detecting the presence of the 5G NR RAN 120, the UE 110 may transmit the corresponding credential information to associate with the 5G NR RAN 120. More specifically, the UE 110 may associate with a specific base station, e.g., the gNB 120A.

The exemplary embodiments relate to a multi-carrier deployment scenario. In the network arrangement 100, the gNB 120A may control multiple cells each operating on a different carrier (e.g., carrier 1, carrier 2, etc.). For example, carrier 1 and carrier 2 may both be deployed by the gNB 120A. However, reference to a single gNB deploying multiple carriers is merely provided for illustrative purposes. In an actual network arrangement, any number of base stations may deploy any appropriate number of carriers.

The network arrangement 100 also includes a cellular core network 130, the Internet 140, an IP Multimedia Subsystem (IMS) 150, and a network services backbone 160. The cellular core network 130 may refer an interconnected set of components that manages the operation and traffic of the cellular network. It may include the evolved packet core (EPC) and/or the 5G core (5GC). The cellular core network 130 also manages the traffic that flows between the cellular network and the Internet 140. The IMS 150 may be generally described as an architecture for delivering multimedia services to the UE 110 using the IP protocol. The IMS 150 may communicate with the cellular core network 130 and the Internet 140 to provide the multimedia services to the UE 110. The network services backbone 160 is in communication either directly or indirectly with the Internet 140 and the cellular core network 130. The network services backbone 160 may be generally described as a set of components (e.g., servers, network storage arrangements, etc.) that implement a suite of services that may be used to extend the functionalities of the UE 110 in communication with the various networks.

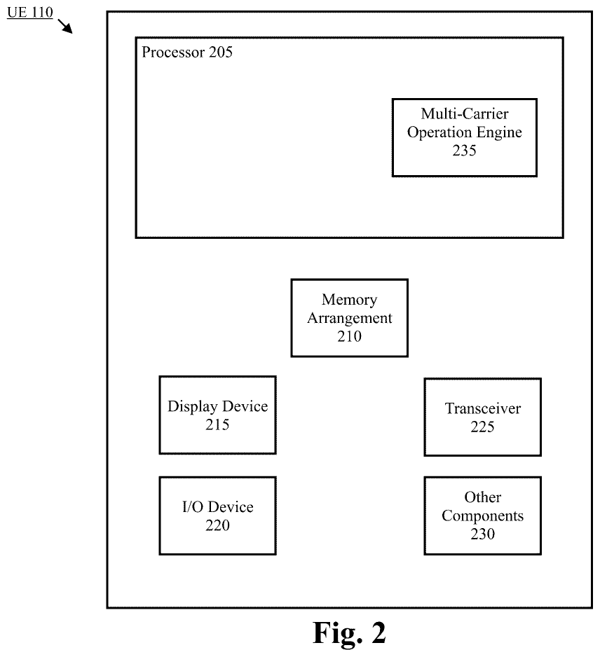

FIG. 2 shows an exemplary UE 110 according to various exemplary embodiments. The UE 110 will be described with regard to the network arrangement 100 of FIG. 1. The UE 110 may include a processor 205, a memory arrangement 210, a display device 215, an input/output (I/O) device 220, a transceiver 225 and other components 230. The other components 230 may include, for example, an audio input device, an audio output device, a power supply, a data acquisition device, ports to electrically connect the UE 110 to other electronic devices, etc.

The processor 205 may be configured to execute a plurality of engines of the UE 110. For example, the engines may include a multi-carrier operation engine 235. The multi-carrier operation engine 235 may perform various operations related to the exemplary techniques introduced herein such as, but not limited to, receiving configuration information, collecting measurement data, performing operations for a RACH procedure, tuning the transceiver 225 to an anchor carrier, tuning the transceiver 225 to a non-anchor carrier, performing operations for BFR, performing operations for RLM, monitoring for paging and receiving pages.

The above referenced engine 235 being an application (e.g., a program) executed by the processor 205 is merely provided for illustrative purposes. The functionality associated with the engine 235 may also be represented as a separate incorporated component of the UE 110 or may be a modular component coupled to the UE 110, e.g., an integrated circuit with or without firmware. For example, the integrated circuit may include input circuitry to receive signals and processing circuitry to process the signals and other information. The engines may also be embodied as one application or separate applications. In addition, in some UEs, the functionality described for the processor 205 is split among two or more processors such as a baseband processor and an applications processor. The exemplary embodiments may be implemented in any of these or other configurations of a UE.

The memory arrangement 210 may be a hardware component configured to store data related to operations performed by the UE 110. The display device 215 may be a hardware component configured to show data to a user while the I/O device 220 may be a hardware component that enables the user to enter inputs. The display device 215 and the I/O device 220 may be separate components or integrated together such as a touchscreen.

The Transceiver 225 May Be a Hardware Component configured to establish a connection with the 5G NR-RAN 120, an LTE-RAN (not pictured), a legacy RAN (not pictured), a WLAN (not pictured), etc. Accordingly, the transceiver 225 may operate on a variety of different frequencies or channels (e.g., set of consecutive frequencies). The transceiver 225 includes circuitry configured to transmit and/or receive signals (e.g., control signals, data signals). Such signals may be encoded with information implementing any one of the methods described herein. The processor 205 may be operably coupled to the transceiver 225 and configured to receive from and/or transmit signals to the transceiver 225. The processor 205 may be configured to encode and/or decode signals (e.g., signaling from a base station of a network) for implementing any one of the methods described herein.

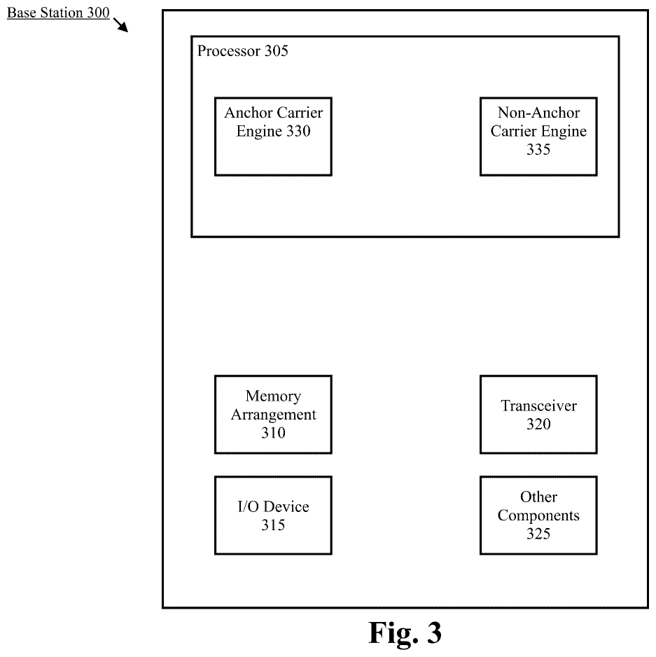

FIG. 3 shows an exemplary base station 300 according to various exemplary embodiments. The base station 300 may represent the gNB 120A or any other access node through which the UE 110 may establish a connection and manage network operations.

The base station 300 may include a processor 305, a memory arrangement 310, an input/output (I/O) device 315, a transceiver 320 and other components 325. The other components 325 may include, for example, an audio input device, an audio output device, a battery, a data acquisition device, ports to electrically connect the base station 300 to other electronic devices and/or power sources, etc.

The processor 305 may be configured to execute a plurality of engines for the base station 300. For example, the engines may include an anchor carrier engine 330 and a non-anchor carrier engine 335. The anchor carrier engine 330 may perform various operations for anchor carriers deployed by the base station 300. The non-anchor carrier engine 335 may perform various operations for non-anchor carriers deployed by the base station 300.

The above noted engines 330, 335 being applications (e.g., a program) executed by the processor 305 is only exemplary. The functionality associated with the engines 330, 335 may also be represented as a separate incorporated component of the base station 300 or may be a modular component coupled to the base station 300, e.g., an integrated circuit with or without firmware. For example, the integrated circuit may include input circuitry to receive signals and processing circuitry to process the signals and other information. In addition, in some base stations, the functionality described for the processor 305 is split among a plurality of processors (e.g., a baseband processor, an applications processor, etc.). The exemplary embodiments may be implemented in any of these or other configurations of a base station.

The memory 310 may be a hardware component configured to store data related to operations performed by the base station 300. The I/O device 315 may be a hardware component or ports that enable a user to interact with the base station 300.

The transceiver 320 may be a hardware component configured to exchange data with the UE 110 and any other UE in the network arrangement 100. The transceiver 320 may operate on a variety of different frequencies or channels (e.g., set of consecutive frequencies). Therefore, the transceiver 320 may include one or more components (e.g., radios) to enable the data exchange with the various networks and UEs. The transceiver 320 includes circuitry configured to transmit and/or receive signals (e.g., control signals, data signals). Such signals may be encoded with information implementing any one of the methods described herein. The processor 305 may be operably coupled to the transceiver 320 and configured to receive from and/or transmit signals to the transceiver 320. The processor 305 may be configured to encode and/or decode signals (e.g., signaling from a UE) for implementing any one of the methods described herein.

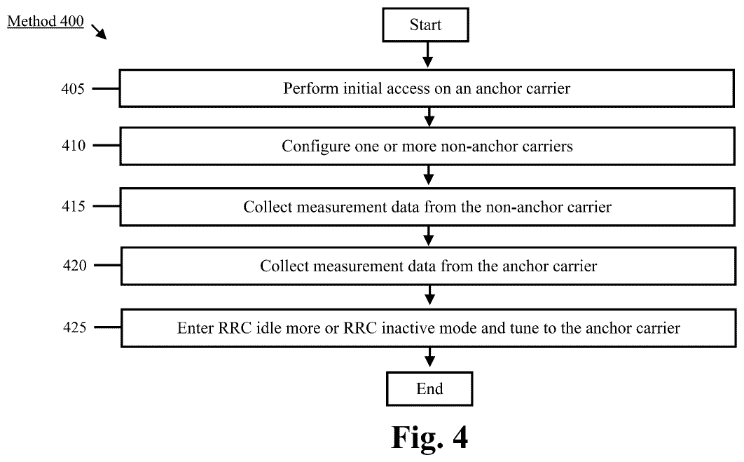

FIG. 4 shows a method 400 for anchor carrier operation according to various exemplary embodiments. The method 400 is described with regard to the network arrangement 100 of FIG. 1 and from the perspective of the UE 110.

In 405, the UE 110 performs initial access on an anchor carrier. The initial access procedure may include a 2-step RACH procedure comprising message A (msgA) and msg B or a 4-step RACH procedure comprising msg 1, msg 2, msg 3 and msg 4. In addition, initial access may include other operations such as, but not limited to, cell search and paging.

As indicated above, from the perspective of the UE 110, an anchor carrier may be a carrier on which the UE 110 assumes that certain types of synchronization information are to be transmitted (e.g., PSS, SSS, PBCH, SIB1, RACH, paging, etc.). In addition, the anchor carrier may be used for broadcast and/or groupcast transmission. Thus, the UE 110 may receive broadcast and/or groupcast signaling via the anchor carrier.

In 410, the UE 110 is configured with one or more non-anchor carriers. For example, after completion of the RACH (e.g., after reception of msg 4 in 4-step RACH or the reception of msg B in 2-step RACH), the UE 110 may be configured with one or more non-anchor carriers via RRC. When the UE 110 is in RRC connected mode, the UE 110 may monitor the one or more non-anchor carriers for unicast transmissions.

As indicated above, from the perspective of the UE 110, a non-anchor carrier may be a carrier on which the UE 110 assumes that certain types of synchronization information are not transmitted (e.g., PSS, SSS, PBCH, SIB1, etc.). Thus, the UE 110 may exchange data in the uplink and/or downlink using the non-anchor carrier but may not receive certain types of synchronization information on the non-anchor carrier.

In some embodiments, if more than one non-anchor carrier is configured, the UE 110 may select one of the non-anchor carriers. In other embodiments, the network may explicitly indicate which non-anchor carrier is to be selected for transmission when more than one non-anchor carrier is configured. For example, an RRC message, downlink control information (DCI) or a medium access control (MAC) control element (CE) may be configured to indicate which non-anchor carrier is to be selected by the UE 110.

According to some aspects, the exemplary embodiments introduce techniques for acquiring timing information of a non-anchor carrier based on the anchor carrier timing and an offset. For example, the UE 110 may acquire the timing information of the anchor carrier based on SSB broadcast by the anchor carrier. In this example, this may occur during initial access (e.g., 405). The UE 110 may then derive the slot timing for the non-anchor carrier based on the timing of the anchor carrier and an offset value. The offset value between the anchor carrier and the non-anchor carrier may be configured via RRC or in any other appropriate manner. In this example, this may be when the non-anchor carrier is configured in 410. In some embodiments, the offset value may be configured on a per non-anchor carrier basis. In other embodiments, an offset value may be common to a group of non-anchor carriers.

According to some aspects, the exemplary embodiments introduce techniques related to uplink power control on the non-anchor carrier. Those skilled in the art will understand that uplink power control refers to a mechanism that allows the UE 110 to determine the power to be used for certain types of uplink transmissions (e.g., PUSCH, PUCCH, sounding reference signals (SRS), physical RACH (PRAHC), etc.). Power control is based on a pathloss estimate and may be derived by the UE 110 using a formula comprising at least a preconfigured received power target assuming full pathloss compensation (P₀) and a power control factor (α). The parameters (P₀) and (α) may be configured in RRC per non-anchor carrier or may be common to a group of non-anchor carriers or common to all non-anchor carriers.

In one approach, the pathloss of a non-anchor carrier may be estimated based on SSB transmitted by the anchor carrier and an offset value provided by the network via RRC signaling. In some embodiments, this offset value may be configured on a per non-anchor carrier basis. In other embodiments, this offset value may be common to a group of non-anchor carriers. Thus, the UE 110 may estimate the pathloss of the non-anchor carrier for uplink power control based on a signal transmitted by the anchor carrier.

In another approach, the pathloss of a non-anchor carrier may be estimated based on a network configured (e. g., gNB 120A) channel state information (CSI)-reference signal (RS) transmitted by the non-anchor carrier. Thus, in contrast to the approach described above, the UE 110 may estimate the pathloss of the non-anchor carrier for uplink power control based on a signal transmitted by the non-anchor carrier.

In 415, the UE 110 collects measurement data from the non-anchor carrier. In 420, the UE 110 collects measurement data from the anchor carrier. For instance, once configured with one or more non-anchor carriers, the UE 110 may tune its transceiver 225 between the anchor carrier and non-anchor carrier to collect measurement data and/or maintain the connections (e.g., beam failure, RLM, RRM, etc.). According to some aspects, the exemplary embodiments introduce a retuning gap pattern for the UE 110 to switch between the anchor carrier and non-anchor carriers.

The retuning gap pattern may be configured via RRC or in any other appropriate manner. The retuning gap pattern may comprise a retuning gap which represents a time duration during which the UE 110 may monitor the anchor carrier. To provide one general example, consider a scenario in which a retuning gap pattern is configured with a retuning gap length of (Y) seconds and a repetition period of (X) seconds. Initially, a first retuning gap is triggered. The UE may tune its transceiver 225 away from a non-anchor carrier to the anchor carrier. After the expiration of the retuning gap duration, the UE 110 may tune back to a non-anchor carrier. A second retuning gap may be triggered (X) seconds after the first retuning gap. The UE 110 may once again tune its transceiver 225 away from the non-anchor carrier to the anchor carrier for (Y) seconds. The above example is merely provided as a general example of a retuning gap pattern and is not intended to limit the exemplary embodiments in any way.

When in RRC connected mode, the UE 110 may perform measurements on the anchor carrier based on SSB broadcast by the anchor carrier. As indicated above, in some embodiments, the UE 110 may perform these measurements during a periodic retuning gap. For example, the UE 110 may tune away from a non-anchor carrier to an anchor carrier during a retuning gap and measure the anchor carrier based on SSB. The UE 110 may then retune back to the same anchor carrier after the retuning gap. In this example, the parameters for the retuning gap pattern may be configured via RRC signaling or in any other appropriate manner.

In other embodiments, a one-shot retuning gap may be configured. In this approach, the network may configure one or more retuning gap parameters via RRC. The network may then trigger the UE 110 to use a retuning gap configuration via DCI or a MAC CE. For example, the UE 110 may receive retuning gap parameters from the network via RRC signaling. The UE 110 may then receive DCI or a MAC CE triggering one of the previously configured retuning gap parameters. In response, the UE 110 may tune away from a non-anchor carrier to an anchor carrier during a retuning gap and measure the anchor carrier based on SSB. The UE 110 may then retune back to the same anchor carrier after the retuning gap.

In other embodiments, the UE 110 may autonomously trigger a retuning gap measurement on an anchor cell based on one or more predetermined conditions. For example, the UE 110 may identify a network condition and/or operate a timer that triggers the UE 110 to utilize a retuning gap. The UE 110 may tune away from a non-anchor carrier to an anchor carrier during a retuning gap and measure the anchor carrier based on SSB. The UE 110 may then retune back to the same anchor carrier after the retuning gap.

In another approach, when the UE 110 is in RRC connected mode, the UE 110 may perform measurements on the non-anchor carrier based on CSI-RS transmitted on the non-anchor carrier with a configurable offset. The offset may be used to compensate the difference caused by measurements of different types of reference signals, e.g., SSB of the anchor carrier, CSI-RS on the non-anchor carrier, etc. The offset value may be configured per non-anchor carrier or may be a common configuration for a group of non-anchor carriers.

As indicated above, the measurements performed in 415-420 may be used for RLM and RRM. The following techniques may be used to perform RLM and/or RRM in a multi-carrier system configured to support an anchor carrier.

In one approach, the UE 110 may perform RLM on the anchor carrier together with connected mode RRM. In some embodiments, a same retuning gap may be used to collect measurement data for RLM and RRM. In other embodiments, at least one retuning gap may be configured for RRM and at least one other retuning gap may be configured for RLM. For example, a first periodic retuning gap pattern may be configured for RRM and a second different periodic retuning gap pattern may be configured for RLC. In another example, a single periodic measurement gap may be configured where a subset of retuning gaps are configured for RLC and a different subset of retuning gaps may be configured for RRM. In a further example, a one-shot retuning gap may be configured for RLC and/or RRM. The network may indicate a retuning gap length and indicate whether the gap is for RLC, RRM or both. In some embodiments, the network may configure the retuning gap and then use layer 1 (L1)/layer 2 (L2) trigger signaling to indicate whether the gap is to be used for RLC, RRM or both.

In another approach, the UE 110 may be configured to first perform RLM on the non-anchor carrier based on CSI-RS. If a triggering condition to declare radio link failure (RLF) occurs based on the RLM, the UE 110 may retune to the anchor carrier instead of declaring RLF. In this approach, the network (e.g., gNB) may decide how to handle the UE 110 after retuning to the anchor carrier. For example, the network may decide to handover the UE 110 to a different anchor carrier or configure the UE 110 to use a different non-anchor carrier. In some embodiments, the UE 110 may perform RLM after retuning back to the anchor carrier and declare RLF if triggered.

In a further approach, the UE 110 may be configured to perform RLM only on the non-anchor carrier based on CSI-RS. In this approach, the UE 110 may declare a RLF on the non-anchor carrier if a RLF triggering condition is met.

In addition, the UE 110 may perform beam failure detection (BFD) and beam failure recovery (BFR) on the anchor carrier together with RRC connected mode RRM. In some embodiments, a same retuning gap may be used for BFD and to collect measurement data for RLM and/or RRM. In other embodiments, at least one retuning gap may be configured for BFD and at least one other retuning gap may be configured for RLM and/or RRM. For example, a first periodic retuning gap pattern may be configured for BED and a second different periodic retuning gap pattern may be configured for RRM and/or RLM. In another example, a single periodic measurement gap may be configured where a subset of retuning gaps are configured for BED and a different subset of retuning gaps may be configured for RRM and/or RLM. Since BFD is performed on the anchor carrier, the UE 110 may trigger BFR on the anchor carrier.

In other embodiments, the UE 110 may be configured to perform BFD on the non-anchor carrier based on CSI-RS. If a triggering condition to declare BFD occurs, the UE 110 may retune to the anchor carrier to perform BFR. In other embodiments, the UE 110 may be configured to perform BFD on the non-anchor carrier based on CSI-RS. If a triggering condition to declare BFD occurs, the UE 110 may perform BFR on the non-anchor carrier.

In 425, the UE 110 enters RRC idle mode or RRC inactive mode and tunes to the anchor carrier. When the UE 110 is operating in RRC idle mode or RRC inactive mode, the UE 110 may only perform measurements on the anchor carrier. Although not shown in the method 400, the UE 110 may perform another RACH procedure to enter RRC connected mode and be configured (or reconfigured) with one or more non-anchor carriers.

In some embodiments, the UE 110 performs a RACH procedure on an anchor carrier. This includes DCI triggered RACH, MAC triggered RACH and RRC triggered RACH. In some embodiments, the UE 110 may be indicated by the network to use one-shot retuning gap via DCI or a MAC CE or may be autonomously triggered to use a one-shot retuning gap to perform RACH on the anchor carrier and then tune back to the non-anchor carrier.

In another approach, the UE 110 may be configured to perform RACH on the non-anchor carrier based on CSI-RS transmitted on the non-anchor carrier. In a further approach, the UE 110 may be configured to perform RACH on a non-anchor carrier based on SSB transmitted on the anchor carrier and a quasi co-location (QCL) indication for the non-anchor carrier. The QCL may be used to map the measured SSB on the anchor carrier and associated RACH resource in the non-anchor carrier. The QCL may be configured per non-anchor carrier or may be common to all non-anchor carrier.

In addition, the exemplary embodiments introduce techniques for paging reception and transmission in a multi-carrier system configured to support an anchor carrier. In one approach, the UE 110 may receive paging on the anchor carrier. For example, when in RRC connected mode, the UE 110 may be configured with a periodic retuning gap to monitor for paging on the anchor carrier.

In another approach, the UE 110 may receive paging on a non-anchor carrier. The network may indicate to the UE 110 that a non-anchor carrier supports paging in a SIB, via RRC signaling or in any other appropriate manner. In addition, the network may provide QCL information to the UE 110 to indicate the beam information used for paging transmission.

In some embodiments, on the network side, the gNB may perform filtering on paging provided from the core network. For example, an access and mobility management function (AMF) may send pages to the gNB 120A for transmission to connected UEs. The gNB 120A may decide whether or not to forward it to cells operating as non-anchor carriers. In this example, for RAN paging, the gNB may not send pages to its cells operating as non-anchor carrier.

In another approach, an AMF may only send core network paging to a gNB with anchor cells. The gNB may then forward the paging to UEs. In this example, for RAN paging, the AMF may not send pages to its cells operating as non-anchor carrier.

### EXAMPLES

In a first example, a method performed by a user equipment (UE), comprising performing initial access on an anchor carrier of a fifth generation (5G) new radio (NR) network and monitoring a non-anchor carrier for a unicast transmission, wherein the non-anchor carrier does not broadcast synchronization signal blocks (SSBs).

In a second example, the method of the first example, wherein the non-anchor carrier does not transmit broadcast system information block (SIB).

In a third example, the method of the first example, further comprising selecting the non-anchor carrier for transmission from a set of multiple non-anchor carriers.

In a fourth example, the method of the third example, further comprising receiving an indication from a base station of the 5G NR network indicating which non-anchor carrier from the set of multiple non-anchor carriers is to be selected for transmission.

In a fifth example, the method of the fourth example, wherein the indication may be provided via layer 1 (L1), layer 2 (L2) or radio resource control (RRC).

In a sixth example, the method of the first example, wherein the UE is configured with a time duration during which the UE is to tune away from the non-anchor carrier and monitor the anchor carrier.

In a seventh example, the method of the sixth example, wherein the UE retunes to the non-anchor carrier after the time duration expires.

In an eighth example, the method of the sixth example, wherein the time duration is one time duration in a periodic pattern of time durations during which the UE is configured to tune away from the non-anchor carrier and perform radio resource management (RRM) based on synchronization signal block (SSB) transmitted by the anchor carrier, wherein the UE is further configured to retune to the non-anchor carrier after the time duration.

In a ninth example, the method of the sixth example, wherein the time duration is a one-shot retuning gap during which the UE is configured to tune away from the non-anchor carrier and perform radio resource management (RRM) based on synchronization signal block (SSB) transmitted by the anchor carrier, wherein the UE is further configured to retune to the non-anchor carrier after the time duration.

In a tenth example, the method of the ninth example, wherein the one-shot retuning gap is triggered by the network via a layer 1 (L1) or layer 2 (L2 ) signal.

In an eleventh example, the method of the sixth example, wherein the UE is autonomously triggered to tune away from the non-anchor carrier and perform radio resource management (RRM) based on synchronization signal block (SSB) transmitted by the anchor carrier during the time duration, wherein the UE is further configured to retune to the non-anchor carrier after the time duration.

In a twelfth example, the method of the sixth example, wherein the time duration is configured via radio resource control (RRC) signaling.

In a thirteenth example, the method of the first example, further comprising entering radio resource control (RRC) connected mode and when in RRC connected mode and monitoring the non-anchor carrier, collecting measurement data based on channel state information (CSI)-reference signal (RS) transmitted by the non-anchor carrier.

In a fourteenth example, the method of the thirteenth example, wherein an offset value is applied to the measurement data based on the CSI-RS to compensate a difference between measurements performed on the CSI-RS transmitted by the non-anchor carrier and a signal synchronization block (SSB) transmitted by the anchor carrier.

In a fifteenth example, the method of the fourteenth example, wherein the offset is provided via radio resource control (RRC) and is dedicated to the non-anchor carrier or is common to multiple non-anchor carrier.

In a sixteenth example, the method of the first example, wherein the UE is configured to perform radio link monitoring (RLM) on reference signals transmitted by the anchor carrier.

In a seventeenth example, the method of the sixteenth example, wherein the UE is configured with one or more retuning gaps during which the UE is to tune away from the non-anchor carrier and perform radio link monitoring (RLM) based on SSB transmitted by the anchor carrier and wherein the UE is further configured to retune to the non-anchor carrier after the retuning gap.

In an eighteenth example, the method of the seventeenth example, wherein a first retuning gap is configured for RLM and a second retuning gap is configured for radio resource management (RRM).

In a nineteenth example, the method of the eighteenth example, wherein the first retuning gap and the second retuning gap are the same retuning gap.

In a twentieth example, the method of the eighteenth example, wherein the first retuning gap and the second retuning gap are different retuning gaps.

In a twenty first example, the method of the eighteenth example, wherein the first retuning gap and the second retuning gap are different retuning gaps of a same periodic retuning gap pattern.

In a twenty second example, the method of the seventeenth example, wherein the one or more retuning gaps are configured by the network via radio resource control signaling, further comprising receiving a layer 1 (L1) or layer 2 (L2) signal from the network indicating whether a retuning gap configured via RRC is to be used for RLM or radio resource management (RRM).

In a twenty third example, the method of the first example, wherein the UE is configured to perform radio link monitoring (RLM) on the non-anchor carrier based on channel state information (CSI)-reference signal (RS) transmitted by the non-anchor carrier.

In a twenty fourth example, the method of the twenty third example, further comprising identifying a radio link failure (RLF) condition on the non-anchor carrier based on the RLM, tuning away from the non-anchor carrier and monitoring the anchor carrier in response to identifying the RLF condition and performing RLM on the anchor carrier.

In a twenty fifth example, the method of the twenty third example, further comprising declaring a radio link failure (RLF) on the non-anchor carrier based on the RLM.

In a twenty sixth example, the method of the first example, further comprising performing beam failure detection (BFD) on the anchor carrier and performing beam failure recovery (BFR) on the anchor carrier.

In a twenty seventh example, the method of the first example, further comprising performing beam failure detection (BFD) on the non-anchor carrier based on channel state information (CSI)-reference signal (RS) transmitted by the non-anchor carrier and performing beam failure recovery (BFR) on the anchor carrier.

In a twenty eighth example, the method of the first example, further comprising performing beam failure detection (BFD) on the non-anchor carrier based on channel state information (CSI)-reference signal (RS) transmitted by the non-anchor carrier and performing beam failure recovery (BFR) on the non-anchor carrier.

In a twenty ninth example, the method of the first example, wherein the UE is configured to perform random access channel (RACH) procedure on the anchor carrier.

In a thirtieth example, the method of the twenty ninth example, further comprising receiving a signal triggering the UE to use a retuning gap and perform the RACH procedure on the anchor carrier and retuning to the non-anchor carrier after the RACH procedure.

In a thirty first example, the method of the first example, wherein the UE is configured to perform random access channel (RACH) procedure on the non-anchor carrier based on channel state information (CSI)-reference signal (RS) transmitted by the non-anchor carrier.

In a thirty second example, the method of the first example, wherein the UE is configured to perform random access channel (RACH) procedure on the non-anchor carrier based on synchronization signal block (SSB) transmitted by the anchor carrier and quasi co-location (QCL) indication between the anchor carrier and the non-anchor carrier.

In a thirty third example, the method of the thirty second example, wherein the QCL indication maps the SSB transmitted by the anchor carrier and associated RACH resource in the non-anchor carrier.

In a thirty fourth example, the method of the first example, wherein the UE is configured to monitor for paging from the anchor carrier during a retuning gap.

In a thirty fifth example, the method of the first example, wherein the UE is configured to monitor for paging on the non-anchor carrier.

In a thirty sixth example, the method of the thirty fifth example, further comprising receiving quasi co-location (QCL) information from the network, the QCL information corresponding to a beam that is to be used for paging transmission.

In a thirty seventh example, the method of the first example, further comprising deriving timing information for the non-anchor carrier based on a slot timing of the anchor carrier and an offset value.

In a thirty eighth example, the method of the thirty seventh example, wherein the offset value is configured via radio resource control (RRC) signaling.

In a thirty ninth example, the method of the thirty eighth example, wherein the offset value is configured on a per non-anchor carrier basis.

In a fortieth example, the method of the thirty eighth example, wherein the offset value is common to a group of non-anchor carriers.

In a forty first example, the method of the thirty seventh example, wherein the slot timing of the anchor carrier is derived based on a synchronization signal block (SSB) transmitted on the anchor carrier.

In a forty second example, the method of the first example, further comprising estimating a pathloss of the non-anchor carrier for uplink power control based on a synchronization signal block (SSB) transmitted on the anchor carrier and an offset value relative to the non-anchor carrier.

In a forty third example, the method of the forty second example, wherein the offset value is configured on a per non-anchor carrier basis.

In a forty fourth example, the method of the forty second example, wherein the offset value is common to a group of non-anchor carriers.

In a forty fifth example, the method of the first example, further comprising estimating a pathloss of the non-anchor carrier for uplink power control based on channel state information (CSI)-reference signal (RS) transmitted on the non-anchor carrier.

In a forty sixth example, a processor configured to perform any of the methods of the first through forty fifth examples.

In a forty seventh example, a user equipment (UE) comprising a transceiver configured to communicate with a network and a processor communicatively coupled to the transceiver and configured to perform any of the methods of the first through forty fifth examples.

Those skilled in the art will understand that the above-described exemplary embodiments may be implemented in any suitable software or hardware configuration or combination thereof. An exemplary hardware platform for implementing the exemplary embodiments may include, for example, an Intel x86 based platform with compatible operating system, a Windows OS, a Mac platform and MAC OS, a mobile device having an operating system such as iOS, Android, etc. The exemplary embodiments of the above described method may be embodied as a program containing lines of code stored on a non-transitory computer readable storage medium that, when compiled, may be executed on a processor or microprocessor.

Although this application described various embodiments each having different features in various combinations, those skilled in the art will understand that any of the features of one embodiment may be combined with the features of the other embodiments in any manner not specifically disclaimed or which is not functionally or logically inconsistent with the operation of the device or the stated functions of the disclosed embodiments.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

It will be apparent to those skilled in the art that various modifications may be made in the present disclosure, without departing from the spirit or the scope of the disclosure. Thus, it is intended that the present disclosure cover modifications and variations of this disclosure provided they come within the scope of the appended claims and their equivalent.

1. An apparatus of a user equipment (UE), the apparatus comprising processing circuitry configure to:
perform initial access on an anchor carrier of a fifth generation (5G) new radio (NR) network; and
monitor a non-anchor carrier for a unicast transmission, wherein the non-anchor carrier does not broadcast synchronization signal blocks (SSBs).

2. The apparatus of claim 1, wherein the non-anchor carrier does not broadcast system information blocks (SIBs).

3. The apparatus of claim 1, wherein the processing circuitry is further configured to:
select the non-anchor carrier for transmission from a set of multiple non-anchor carriers.

4. The apparatus of claim 3, wherein the processing circuitry is further configured to:
process, based on signaling received from a base station of the 5G NR network, an indication as to which non-anchor carrier from the set of multiple non-anchor carriers is to be selected for transmission.

5. The apparatus of claim 1, wherein the UE is configured with a time duration during which the UE is to tune away from the non-anchor carrier and monitor the anchor carrier.

6. The apparatus of claim 5, wherein the UE retunes to the non-anchor carrier after the time duration expires.

7. The apparatus of claim 5, wherein the time duration is one time duration in a periodic pattern of time durations during which the UE is configured to tune away from the non-anchor carrier and perform radio resource management (RRM) based on synchronization signal block (SSB) transmitted by the anchor carrier, wherein the UE is further configured to retune to the non-anchor carrier after the time duration.

8. The apparatus of claim 5, wherein the time duration is a one-shot retuning gap during which the UE is configured to tune away from the non-anchor carrier and perform radio resource management (RRM) based on synchronization signal block (SSB) transmitted by the anchor carrier, wherein the UE is further configured to retune to the non-anchor carrier after the time duration.

9. The apparatus of claim 5, wherein the UE is autonomously triggered to tune away from the non-anchor carrier and perform radio resource management (RRM) based on synchronization signal block (SSB) transmitted by the anchor carrier during the time duration, wherein the UE is further configured to retune to the non-anchor carrier after the time duration.

10. The apparatus of claim 1, wherein the processing circuitry is further configured to:
enter radio resource control (RRC) connected mode; and
when in RRC connected mode and monitoring the non-anchor carrier, collect measurement data based on channel state information (CSI)-reference signal (RS) transmitted by the non-anchor carrier.

11. The apparatus of claim 10, wherein an offset value is applied to the measurement data based on the CSI-RS to compensate a difference between measurements performed on the CSI-RS transmitted by the non-anchor carrier and a signal synchronization block (SSB) transmitted by the anchor carrier.

12. The apparatus of claim 1, wherein the UE is configured to perform radio link monitoring (RLM) on reference signals transmitted by the anchor carrier.

13. The apparatus of claim 12, wherein the UE is configured with one or more retuning gaps during which the UE is to tune away from the non-anchor carrier and perform radio link monitoring (RLM) based on SSB transmitted by the anchor carrier and wherein the UE is further configured to retune to the non-anchor carrier after each of the one or more retuning gaps.

14. The apparatus of claim 13, wherein a first retuning gap is configured for RLM and a second retuning gap is configured for radio resource management (RRM).

15. The apparatus of claim 14, wherein the first retuning gap and the second retuning gap comprise (i) a same retuning gap, (ii) different retuning gaps, or (iii) different retuning gaps of a same periodic retuning gap pattern.

16. The apparatus of claim 13, wherein the one or more retuning gaps are configured by the network via radio resource control signaling, wherein the processing circuitry is further configured to:
process, based on signaling received from the network, a layer 1 (L1) or layer 2 (L2) signal indicating whether retuning gaps of the one or more retuning gaps configured via RRC are to be used for RLM or radio resource management (RRM).

17. The apparatus of claim 1, wherein the UE is configured to perform radio link monitoring (RLM) on the non-anchor carrier based on channel state information (CSI)-reference signal (RS) transmitted by the non-anchor carrier.

18. The apparatus of claim 17, wherein the processing circuitry is further configured to:
identify a radio link failure (RLF) condition on the non-anchor carrier based on the RLM;
tune away from the non-anchor carrier and monitoring the anchor carrier in response to identifying the RLF condition; and
perform RLM on the anchor carrier.

19. The apparatus of claim 17, wherein the processing circuitry is further configured to:
declare a radio link failure (RLF) on the non-anchor carrier based on the RLM.

20. The apparatus of claim 1, wherein the processing circuitry is further configured to:
perform beam failure detection (BFD) on the anchor carrier; and
perform beam failure recovery (BFR) on the anchor carrier.
